(19) United States
(12) Patent Application Publication
(10) Pub. No.: US 2008/0200236 A1
(43) Pub. Date: Aug. 21, 2008

(54) SLOT MACHINE AND CONTROL METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/026,162

(22) Filed: Feb. 5, 2008

(30) Foreign Application Priority Data
Feb. 5, 2007 (JP) JP2007-025409

(51) Int. Cl. A63F 13/00

(52) U.S. Cl. 463/20

(57) ABSTRACT

A slot machine includes a first liquid crystal display, a second liquid crystal display, and a CPU. The CPU performs a slot game in which one selected from among a plurality of symbols is displayed in each of a plurality of display regions of the first liquid crystal display and performs an effect display regarding a result of the slot game on the first liquid crystal display. The CPU performs an effect display regarding the result of the slot game on the second liquid crystal display. The CPU coordinates displays of the first liquid crystal display and the second liquid crystal display to perform the effect displays on the first liquid crystal display and the second liquid crystal display.

### CROSS REFERENCE TO RELATED APPLICATION

This application claims benefit of priority under 35 U.S.C. § 119 to Japanese Patent Application No. 2007-025409, filed on Feb. 5, 2007, the entire contents of which are incorporated by reference herein.

### BACKGROUND OF THE INVENTION

1. Field of the Invention

The present invention relates to a slot machine having a display, and to a control method of the slot machine.

2. Description of the Related Art

In a conventional slot machine, when a player inserts a predetermined number of medals into a medal insertion slot and operates a start button, a plurality (for example, three) of reels, on each of which a plurality of symbols are drawn, rotate individually. Thereafter, when a predetermined time elapses, the reels stop. At this time, when symbols which compose a winning combination stop on a pre-set payline, or when a predetermined number of scatter symbols stop, a payout corresponding to the number of inserted medals is generated.

Meanwhile, U.S. Patent Application Publication No. 2002/0025843 describes that images of a plurality of reels and an effect image are displayed on one display, and that motion picture display in which the displayed reels rotate is performed. As described above, in the conventional slot machine, the effect image and the rotation images of the plurality of reels have been individually displayed on one image display unit.

A slot machine provided with a new entertainment factor has been desired to appear, in which the slot machine is based on the conventional one described above.

### SUMMARY OF THE INVENTION

It is an object of the present invention to provide a slot machine capable of enhancing an entertainment factor thereof, and to provide a control method of the slot machine.

In order to achieve the above-described object, the present invention provides a slot machine, which includes: a first display on which a slot game is performed to display one selected from among a plurality of symbols in each of a plurality of display regions thereof and on which an effect display regarding a result of the slot game is performed; a second display on which an effect display regarding the result of the slot game is performed; and a controller that coordinates displays of the first display and the second display to perform the effect displays on the first display and the second display.

In accordance with the present invention, the effect displays regarding the result of the slot game are performed on the first and second displays in a coordination manner. In such a way, it becomes possible to perform new effect display regarding a change of circumstances of the game.

In a preferred embodiment of the present invention, the controller displays the result of the slot game on the first display and performs on the second display an effect display regarding a magnitude of an award generated in response to the result of the slot game.

In accordance with this embodiment, the result of the slot game is displayed on the first display, and the effect display regarding the magnitude of the award generated in response to the result of the slot game is displayed on the second display in coordination with the display on the first display. In such a way, it becomes possible to perform new effect display regarding the magnitude of the award generated in response to the result of the slot game.

In a preferred embodiment of the present invention, the controller displays on the first display a notification that a jackpot is won as the result of the slot game and performs on the second display the effect display regarding the result of the slot game to decide a payout for the winning.

In accordance with this embodiment, the notification that the jackpot is won is displayed as the result of the slot game on the first display, and the effect display regarding the result of the slot game, the effect display being for deciding the payout for the winning of the jackpot, is performed on the second display in coordination with the display on the first display. In such a way, it becomes possible to perform new effect display related to the winning of the jackpot.

In a preferred embodiment of the present invention, the slot game shifts to a game advantageous to a player when one or more first specific symbols are displayed in a predetermined number of the display regions and the controller performs the effect displays when a second specific symbol is displayed in at least one of the display regions in the game advantageous to the player.

In accordance with this embodiment, the slot game that shifts to the game advantageous to the player is executed on the first display, and the effect displays regarding a result of the game advantageous to the player are performed on the first and second displays in the coordination manner. In such a way, in the slot game that proceeds to the game advantageous to the player, it becomes possible to perform new effect display regarding the change of the circumstances of the game.

In order to achieve the above-described object, the present invention provides a slot machine, which includes: a first display on which a slot game is performed to display one selected from among a plurality of symbols in each of a plurality of display regions thereof; a second display on which an effect display regarding a result of the slot game is performed; and a controller that displays the result of the slot game on the first display and performs on the second display an effect display regarding a magnitude of an award generated in response to the result of the slot game.

In accordance with the present invention, the result of the slot game is displayed on the first display, and the effect display regarding the magnitude of the award generated in response to the result of the slot game is performed on the second display. In such a way, it becomes possible to perform new effect display regarding the magnitude of the award generated in response to the result of the slot game.

In a preferred embodiment of the present invention, the controller displays on the first display a notification that a jackpot is won as the result of the slot game and performs on the second display the effect display regarding the result of the slot game to decide a payout for the winning.

In accordance with this embodiment, the notification that the jackpot is won is displayed as the result of the slot game on the first display, and the effect display regarding the result of the slot game, the effect display being for deciding the payout for the winning of the jackpot, is performed on the second display. In such a way, it becomes possible to perform new effect display related to the winning of the jackpot.

In a preferred embodiment of the present invention, the slot game shifts to a game advantageous to a player when one or more first specific symbols are displayed in a predetermined number of the display regions and the controller performs the effect display regarding the magnitude of the award when a second specific symbol is displayed in at least one of the display regions in the game advantageous to the player.

In accordance with this embodiment, the slot game that shifts to the game advantageous to the player is executed on the first display, and the effect display regarding a result of the game advantageous to the player is performed on the second display. In such a way, in the slot game that shifts to the game advantageous to the player, it becomes possible to perform new effect display regarding the change of the circumstances of the game.

In a preferred embodiment of the present invention, when a symbol indicating that a jackpot is won is displayed as the second specific symbol, the controller performs the effect display regarding the magnitude of the award to decide a payout for the winning.

In accordance with this embodiment, the slot game that shifts to the game advantageous to the player is executed on the first display, and the effect display regarding the winning of the jackpot in the game advantageous to the player is performed on the second display. In such a way, in the slot game that shifts to the game advantageous to the player, it becomes possible to perform new effect display regarding the change of the circumstances of the game.

In order to achieve the above-described object, the present invention provides a slot machine which includes: a first display on which a slot game is performed to display one selected from among a plurality of symbols in each of a plurality of display regions thereof; a second display on which an effect display regarding a result of the slot game is performed; and a controller that displays on the first display a notification that a jackpot is won as the result of the slot game and performs on the second display the effect display regarding the result of the slot game to decide a payout for the winning.

In accordance with the preset invention, the notification that the jackpot is won is displayed as the result of the slot game on the first display, and the effect display regarding the result of the slot game, the effect display being for deciding the payout for the winning of the jackpot, is performed on the second display. In such a way, it becomes possible to perform new effect display related to the winning of the jackpot.

In a preferred embodiment of the present invention, the controller performs the effect display when the jackpot is won and a condition for shifting to a game advantageous to a player is satisfied as the result of the slot game.

In accordance with this embodiment, the slot game that shifts to the game advantageous to the player is executed on the first display, and the effect display regarding the winning of the jackpot in the game advantageous to the player is performed on the second display. In such a way, in the slot game that shifts to the game advantageous to the player, it becomes possible to perform new effect display regarding the change of the circumstances of the game.

In order to achieve the above-described object, the present invention provides a slot machine, which includes: a first display on which a slot game is performed to display one selected from among a plurality of symbols in each of a plurality of display regions thereof and on which an effect display regarding a result of the slot game is performed; a second display on which an effect display regarding the result of the slot game is performed; and a controller that coordinates displays of the first display and the second display to perform the effect displays on the first display and the second display, wherein, when a jackpot is won and a condition for shifting to a game advantageous to a player is satisfied as the result of the slot game, the controller performs the effect displays to decide a payout for the winning.

In accordance with the present invention, the notification that the jackpot is won is displayed as the result of the slot game on the first display, and the effect displays regarding the result of the slot game, the effect display being for deciding the payout for the winning of the jackpot, are performed on the first and second displays. In such a way, it becomes possible to perform new effect display related to the winning of the jackpot.

In a preferred embodiment of the present invention, the slot game shifts to the game advantageous to the player when one or more first specific symbols are displayed in a predetermined number of the display regions and the controller performs the effect displays when a second specific symbol is displayed in at least one of the display regions in the game advantageous to the player.

In accordance with this embodiment, the slot game that shifts to the game advantageous to the player is executed on the first display, and the effect display regarding the winning of the jackpot in the game advantageous to the player is performed on the second display. In such a way, in the slot game that shifts to the game advantageous to the player, it becomes possible to perform new effect display regarding the change of the circumstances of the game.

In order to achieve the above-described object, the present invention provides a method for controlling a slot machine which includes: performing a slot game in which one selected from among a plurality of symbols is displayed in each of a plurality of display regions of a first display provided on the slot machine; and performing effect displays regarding a result of the slot game on the first display and a second display provided on the slot machine in a coordination manner.

In accordance with the present invention, the effect displays regarding the result of the slot game are performed on the first and second displays in the coordination manner. In such a way, it becomes possible to perform new effect display regarding the change of the circumstances of the game.

### BRIEF DESCRIPTION OF THE DRAWINGS

FIG. 1 is an explanatory view showing a display example displayed on liquid crystal displays of a slot machine according to an embodiment of the present invention.

FIG. 2 is a perspective view of the slot machine according to the embodiment of the present invention.

FIG. 3 is a block diagram showing a control circuit of a slot machine according to the embodiment of the present invention.

FIG. 4 is a schematic diagram showing a storage area of a RAM of the slot machine according to the embodiment of the present invention.

FIG. 5 is a schematic diagram showing a payout table stored in a ROM of the slot machine according to the embodiment of the present invention.

FIG. 6 is a flowchart showing a slot game processing procedure of the slot machine according to the embodiment of the present invention.

FIG. 7 is a flowchart showing a bonus game processing procedure of the slot machine according to the embodiment of the present invention.

FIG. 8A is a schematic diagram showing a display example of a slot game executed on a liquid crystal display of the slot machine according to the embodiment of the present invention.

FIG. 8B is a schematic diagram showing a display example of the slot game executed on the liquid crystal display of the slot machine according to the embodiment of the present invention.

FIG. 9A is a schematic diagram showing a display example of the slot game executed on the liquid crystal display of the slot machine according to the embodiment of the present invention.

FIG. 9B is a schematic diagram showing a display example of the slot game executed on the liquid crystal display of the slot machine according to the embodiment of the present invention.

FIG. 9C is a schematic diagram showing a display example of the slot game executed on the liquid crystal display of the slot machine according to the embodiment of the present invention.

FIG. 10 is a schematic diagram showing a display example of an effect executed on the liquid crystal displays of the slot machine according to the embodiment of the present invention.

FIG. 11 is a schematic diagram showing a display example of the effect executed on the liquid crystal displays of the slot machine according to the embodiment of the present invention.

### DETAILED DESCRIPTION OF THE PREFERRED EMBODIMENTS

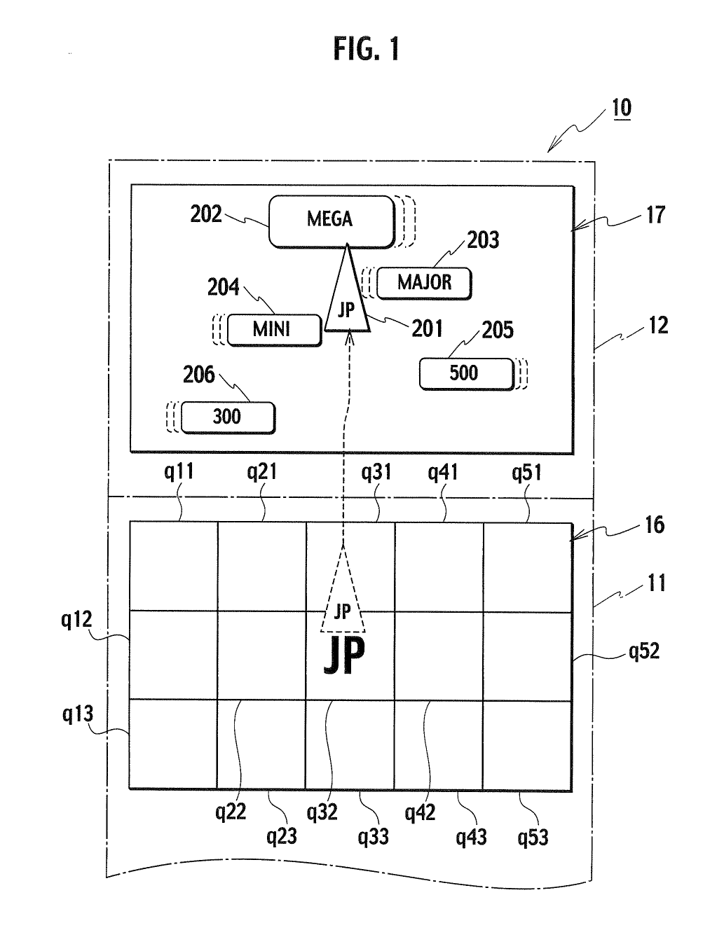

A description will be made below in detail of an embodiment of the present invention with reference to FIGS. 1 to 11.

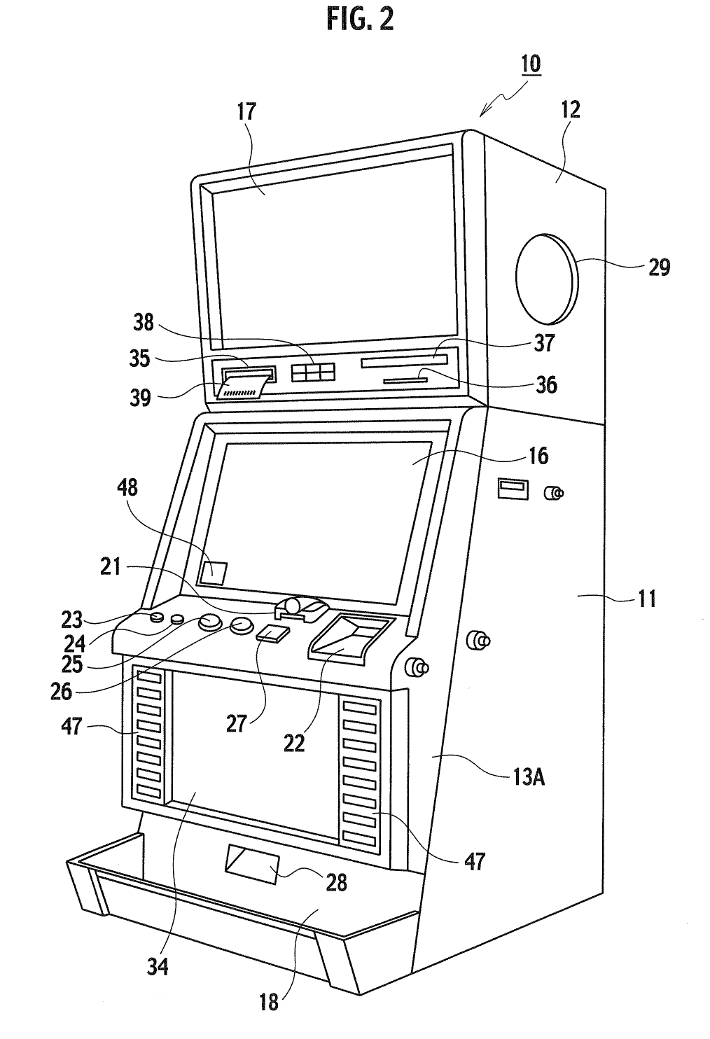

First, a description will be made of characteristic portions of the embodiment of the present invention with reference to FIG. 1 and FIG. 2. A slot machine 10 includes a cabinet 11, and a top box 12 provided on the cabinet 11. On a front surface side of the cabinet 11, which faces to a player, a first liquid crystal display 16 (a first display) is provided. Moreover, on a front surface side of the top box 12, which faces to the player, a second liquid crystal display 17 (a second display) is provided. In this embodiment, effect display regarding a slot game is performed, in a coordination manner, on the first and second liquid crystal displays 16 and 17 concurrently provided up and down.

Specifically, the slot game is executed on the first liquid crystal display 16, and effect display regarding a result of the slot game is performed on the first and second liquid crystal displays 16 and 17 in the coordination manner.

Specifically, as shown in FIG. 1, in the slot machine 10, totally 15 display regions q11 to q53 with a matrix of three rows and five columns are set on the first liquid crystal display 16, and the slot game is executed on the respective display regions q11 to q53. In this slot game, a medal is inserted into the slot machine 10, or a BET switch 25 (FIG. 2) is pressed, whereby a credit is bet. When the credit is bet, and a START switch 27 (FIG. 2) is pressed, variable display is performed on each of the display regions q11 to q53. The variable display stands for that a plurality of symbols are sequentially displayed by turns on one display region. In the slot game, this variable display is executed individually on each of the display regions q11 to q53. Moreover, the respective variable displays on the display regions q11 to q53 are performed simultaneously. Then, on each of the display regions q11 to q53, one selected from among the plurality of symbols is displayed still.

When the symbols are displayed still on all of the display regions q11 to q53, an award is generated based on a combination of the symbols thus displayed still and on displayed positions thereof, and credits corresponding to a magnitude of the generated award are given to the player.

In the slot machine 10, when a special award is generated as the result of the slot game executed on the first liquid crystal display 16, a game effect that decides a magnitude of the award concerned is performed on the first and second liquid crystal displays 16 and 17 in the coordination manner.

For example, the slot game executed on the first liquid crystal display 16 proceeds to a game advantageous to the player (hereinafter, the game is referred to as a bonus game) in response to that a special symbol (a bonus symbol) is displayed still thereon. When a symbol (letters “JP” in an example of FIG. 1) representing that a jackpot (JP) as the special award has been won is displayed still on one (for example, the display region q32) of the displayed regions q11 to q53 in the bonus game (FIG. 1), a game effect that decides a magnitude of the award generated following the winning of the jackpot is performed on the first and second liquid crystal displays 16 and 17 in the coordination manner. Note that the symbol is a notification that the jackpot has been won. In this effect, the symbol (the letters “JP”) representing that the jackpot has been won is changed into a character 201 resembling a rocket, and the character 201 moves from the first liquid crystal display 16 toward the second liquid crystal display 17.

When the character 201 disappears from a frame of the first liquid crystal display 16, the character 201 is displayed on the second liquid crystal display 17. In such a way, the effect looking like as if the character 201 moved from the first liquid crystal display 16 to the second liquid crystal display 17 is performed by the coordination of the displays of the two liquid crystal displays.

On the second liquid crystal display 17, when the game effect that decides the magnitude of the award generated following the winning of the jackpot is started, characters 202 to 206 corresponding to such magnitudes of the award are displayed so as to move in a left-and-right direction. Then, such effect display is performed, in which the character 201 that rises from below hits any of the characters 202 to 206.

The respective characters 202 to 206 are individually associated with the magnitudes of the award. The character 202 is a character associated with the largest award (“MEGA” in the jackpot). The character 203 is a character associated with the second largest award (“MAJOR” in the jackpot). The character 204 is a character associated with the third largest award (“MINI” in the jackpot”). The characters 205 and 206 are characters associated with payouts (500 pieces and 300 pieces) to be given to the player.

In the slot game, the magnitude of the award to be given to the player is decided in response to the result thereof. When the jackpot as the special award has been won, the following effect is performed in effect display corresponding to a result of this winning (that is, a game result). In the effect display, the character 201 resembling the rocket hits the character (any of the characters 202 to 206) corresponding to the magnitude of the award to be given to the player. After the effect display, the award is given to the player.

As described above, in the slot machine 10 of this embodiment, as the effect display corresponding to the result of the slot game, the game effect that decides the magnitude (the payout) of the award generated in accordance with the result of the slot game is displayed on the first and second liquid crystal displays 16 and 17 in the coordination manner. Here, the game effect is one in which the character 201 hits any of the characters 202 to 206. In such a way, it becomes possible to perform new effect display, for example, corresponding to game circumstances that the jackpot has been won.

The description has been made above of the case where, in each slot game, the symbols displayed on the respective display regions vary, and new symbols are displayed thereon; however, the slot game is not limited to the case of variably displaying the symbols on the respective display regions q11 to q53. For example, such scroll display may be performed, in which each of the respective columns of the display regions q11 to q13, q21 to q23, q31 to q33, q41 to q43, and q51 to q53 is displayed like one reel, and the respective reels are made to look like rotating. In this case, a configuration may be adopted, in which a payline is set, and the award is generated by the fact that specific symbols are displayed still on the payline.

Moreover, the effect display performed on the first and second liquid crystal displays 16 and 17 in the coordination manner is not limited to such effect display, in which the first and second liquid crystal displays 16 and 17 are utilized like one screen, and the one character 201 is displayed and moves on that screen. Such a configuration may be adopted, in which individual characters (first and second characters) are displayed in advance on the first liquid crystal display 16 and the second liquid crystal display 17, and effect of the second character on the second liquid crystal display 17 is executed in response to effect of the first character on the first liquid crystal display 16. Specifically, effect display may be performed, in which the characters displayed on the first and second liquid crystal displays 16 and 17 are displayed as individually independent ones, and motions of these characters coordinate with each other.

Furthermore, the slot machine according to the present invention is not limited to the one to perform the effect display by using both of the first and second liquid crystal displays 16 and 17. Such coordination to display the result of the slot game and to perform effect display in response to the result concerned may be performed on the first and second liquid crystal displays 16 and 17, for example, so that the slot game can be executed on the first liquid crystal display 16, and that effect display corresponding to a result of the slot game can be executed on the second liquid crystal display 17.

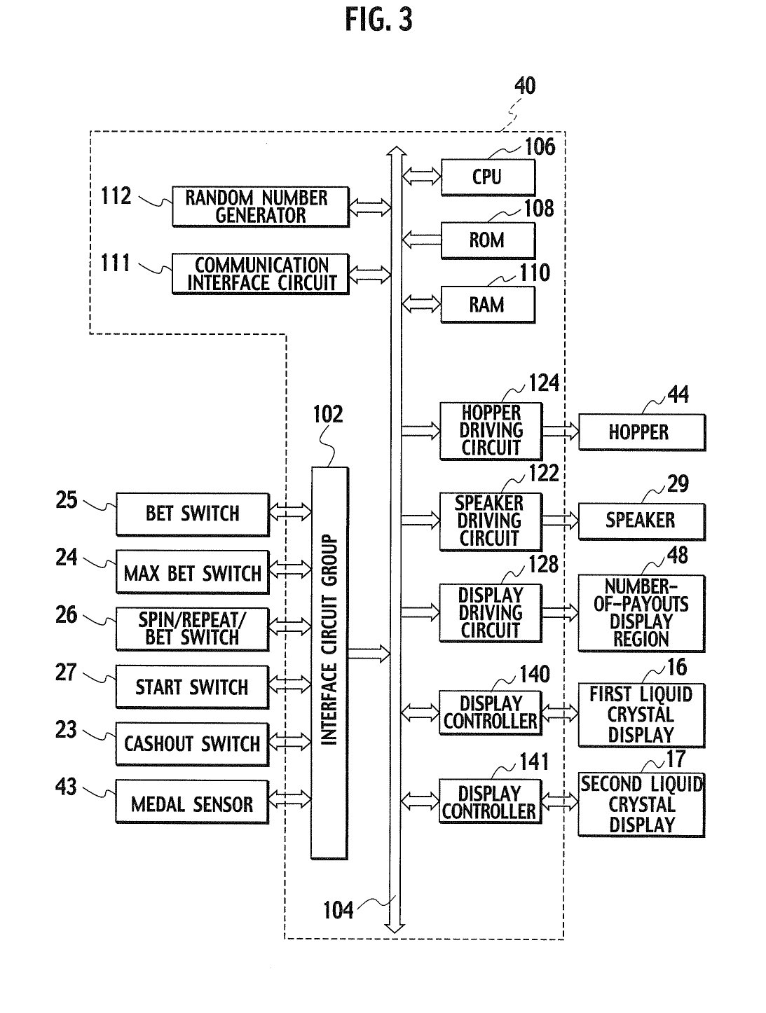

Next, a description will be made in detail of the slot machine 10 according to this embodiment. As shown in FIG. 2, the slot machine 10 includes: the cabinet 11; the top box 12 provided on the cabinet 11; and a main door 13. The first liquid crystal display 16 is provided on the surface of the cabinet 11, which faces to the player. In the cabinet 11, there are provided a variety of constituent members including: a controller 40 (refer to FIG. 3) for electrically controlling the slot machine 10; a hopper (refer to FIG. 3) for controlling insertion, storage and payout of medals; and the like.

In this embodiment, the medals are mentioned as an example of game mediums for use in the case of executing the game; however, the game mediums are not limited to the medals. For example, tokens, electronic money, or electronic valuable information (credits) equivalent to these can be mentioned.

The main door 13 is attached onto the cabinet 11 so as to be openable and closable. On a substantial center of the main door 13, the first liquid crystal display 16 is provided. On the first liquid crystal display 16, the totally 15 display regions q11 to q53 with a matrix of three rows and five columns are provided. The variety of symbols are displayed on these respective display regions. Specifically, when the slot game is started, the symbols displayed on the respective display regions start the variable display simultaneously, and after a predetermined time elapses, the symbols stop. Then, the payout is generated in response to the combination of the symbols which have stopped on the respective display regions.

On a lower left region of the first liquid crystal display 16, a number-of-payouts display region 48 for displaying the number of payouts is provided.

Below the first liquid crystal display 16, there are provided: a medal insertion slot 21 for inserting therethrough the medals for use in the case of playing the game; and a bill identifier 22 for identifying whether or not a bill is a real one and receiving the real bill. A variety of operation switches are provided in the vicinities of the medal insertion slot 21 and the bill identifier 22.

As the operation switches, there are provided: a CASHOUT switch 23; a MAX BET switch 24; a BET switch 25; a SPIN/REPEAT/BET switch 26; and a START switch 27.

The BET switch 25 is a switch for deciding the number of credits to be bet on the slot game executed on the first liquid crystal display 16. As will be described later, every time when the BET switch 25 is pressed, a credit equivalent to one medal is bet.

The SPIN/REPEAT/BET switch 26 is a switch for betting credits again without changing the number of credits bet by the BET switch 25 in the game executed last time, thereby performing the slot game.

The START switch 27 is a switch for starting the slot game after the desired number of medals are bet. When the START switch 27 is pressed after the medals are inserted into the medal insertion slot 21 or after the credits are bet by the BET switch 25, the slot game is started on the first liquid crystal display 16.

The CASHOUT switch 23 is a switch for paying out the inserted medals. The medals to be paid out is discharged from a medal payout port 28 open at a lower portion of a front surface of the main door 13, and the discharged medals are accumulated in a medal tray 18.

The MAX BET switch 24 is a switch for betting, by one operation, the maximum number (for example, equivalent to 30 medals) of credits bettable in one game.

On the front surface of the lower portion of the main door 13, a foot display 34 is provided, and displays a variety of images regarding the games of the slot machine 10. As such images, for example, a character of the slot machine 10 and the like can be mentioned.

On both sides of the foot display 34, lamps 47 are provided, and emit light based on a light-emitting pattern pre-set for the play of the slot machine 10. The medal payout port 28 is provided below the foot display 34.

On the front surface of the top box 12, the second liquid crystal display 17 is provided. As described above, on the second liquid crystal display 17, the effect display corresponding to the result of the slot game executed on the first liquid crystal display 16 is performed in coordination with the display on the first liquid crystal display 16.

Speakers 29 are provided in the top box 12. Below the second liquid crystal display 17, there are provided: a ticket printer 35; a card reader 36; a data display 37; and a keypad 38. The ticket printer 35 prints, on a ticket, a bar code in which the respective data such as the number of credits, a date, and an identification number of the slot machine 10 are encoded, and outputs the ticket as a bar code-added ticket 39.

The player allows another slot machine to read the bar code-added ticket 39, and thereby can perform the game on the slot machine concerned, and can exchange the bar code-added ticket 39 with bills and the like at a predetermined spot (for example, a casher in a casino) of a game arcade.

The card reader 36 is capable of receiving a smart card, and reads data from the smart card inserted thereinto, and writes data into the smart card. The smart card is a card carried by the player, in which data for identifying the player, data regarding a history of the games performed by the player, and the like are stored.

FIG. 3 is a block diagram showing an electric configuration of the controller 40 provided in the slot machine 10 according to this embodiment, and of the variety of instruments connected to the controller 40. The controller 40 of the slot machine 10, which is shown in FIG. 3, is a microcomputer, and includes: an interface circuit group 102; an input/output bus 104; a CPU 106; a ROM 108; a RAM 110; a communication interface circuit 111; a random number generator 112; a speaker driving circuit 122; a hopper driving circuit 124; a display driving circuit 128; and a display controller 140.

The interface circuit group 102 is connected to the input/output bus 104, and the input/output bus 104 transfers a data signal or an address signal to the CPU 106.

The START switch 27 is connected to the interface circuit group 102. A starting signal outputted from the START switch 27 is converted into a predetermined signal in the interface circuit group 102, and is then transmitted to the CPU 106 through the input/output bus 104.

Moreover, to the interface circuit group 102, there are connected: the BET switch 25; the MAX BET switch 24; the SPIN/REPEAT/BET switch 26; and the CASHOUT switch 23. The respective switching signals outputted from the respective switches 25, 24, 26 and 23 are supplied to the interface circuit group 102, are converted into predetermined signals in the interface circuit group 102, and are then transmitted to the CPU 106 through the input/output bus 104.

In addition, a medal sensor 43 is connected to the interface circuit group 102. The medal sensor 43 is a sensor for detecting the medals inserted into the medal insertion slot 21, and is provided in a medal insertion spot of the medal insertion slot 21. A detection signal outputted by the medal sensor 43 is supplied to the interface circuit group 102, is converted into a predetermined signal by the interface circuit group 102, and is then transmitted to the CPU 106 through the input/output bus 104.

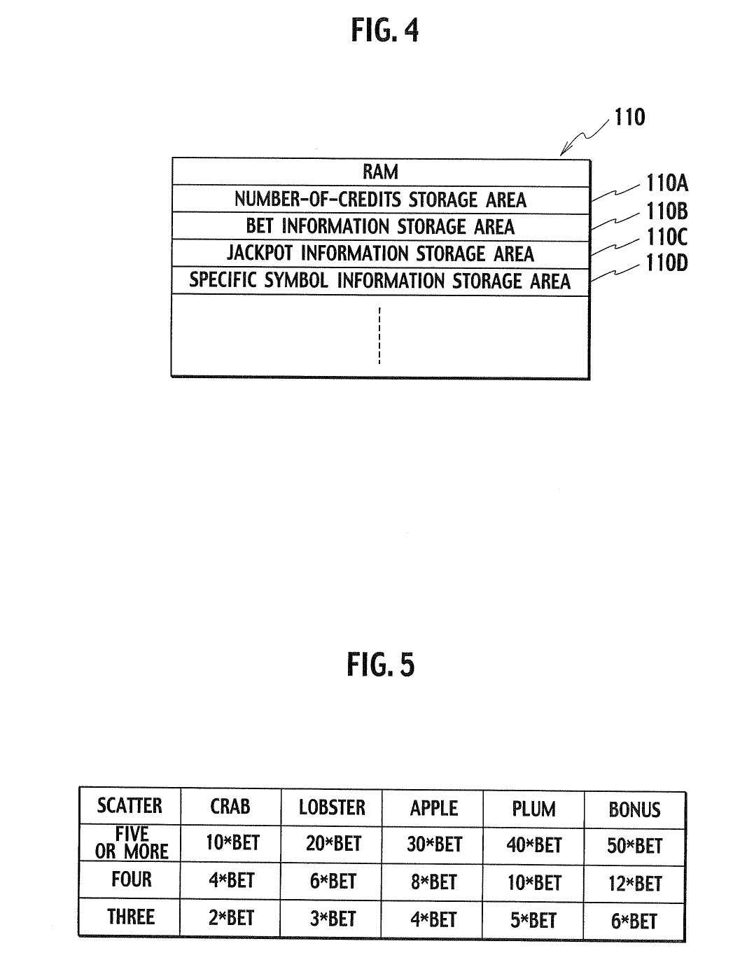

To the input/output bus 104, there are connected: the ROM 108 in which a system program is stored; and the RAM 110 for storing a variety of data. As shown in FIG. 4, the RAM 110 includes: a number-of-credits storage area 110A for storing the number of credits owned by the player; a bet information storage area 110B for storing the number of bet credits (that is, bet information); a jackpot information storage area 110C for storing jackpot information; and the like.

The number of credits owned by the player is updated in the case where the medals are bet and in the case where the award (credits) is generated in accordance with the result of the slot game. The bet information is updated in the case where the bet is made by the player. Moreover, the jackpot information is information to be supplied to a plurality of the slot machines 10 from a hall server (not shown) that manages the respective slot machines 10. The jackpot information is classified into types of the winning, which are “MEGA”, “MAJOR”, “MINI”, “500” and “300”, in accordance with the magnitude of the number of credits given in the case where the winning of the jackpot is generated.

“MEGA” is the number of payouts, which is calculated in the largest ratio with respect to the accumulated number of credits bet in the plurality of slot machines 10. “MAJOR” is the number of payouts, which is calculated in the second largest ratio with respect to the accumulated number described above. “MINI” is the number of payouts, which is calculated in the third largest ratio with respect to the accumulated number described above. Moreover, “500” and “300” are types of the winning, in which the number of credits given in the case where the winning of the jackpot is generated is fixed to 500 and 300.

Every time when the bet information is obtained from each of the slot machines 10, the hall server obtains the number of payouts, which is calculated in a ratio corresponding to the type of the winning of the jackpot with respect to the number of bets. Then, the hall server issues a notice on the number of payouts to each of the slot machines 10. In such a way, every time when such jackpot winning (to be described later) is generated, each of the slot machines 10 reads out the number of payouts, which corresponds to the type of the winning (“MEGA”, “MAJOR”, “MINI”, “500” or “300”), from the jackpot information storage area 110C of the RAM 110. Then, each of the slot machines 10 adds the read number of credits to the number of credits, which is stored in the number-of-credits storage area 110A, thereby giving the read number of credits to the player.

A payout table shown in FIG. 5 is stored in the ROM 108. The payout table shows correspondence relationships between conditions for paying out the medals and the payout numbers of medals in the case where the conditions are satisfied. The conditions for paying out the medals are shown by the symbols which have stopped on any of the display regions q11 to q53, that is, stopped symbols, and by the number of stopped symbols. In the slot game of this embodiment, the CPU 106 decides whether or not to give the credits (to pay out the medals) and the number of given credits (the payout number of medals) based on the payout table shown in FIG. 5 and on the symbols which have stopped on the respective display regions q11 to q53. In accordance with this payout table, for example, when five or more pieces of “PLUM” have stopped on the display regions q11 to q53, the payout number becomes a value obtained by multiplying the number of bets by 40. Here, the number of bets is the number of medals bet on such a unit game concerned.

As described above, in the slot machine 10 of this embodiment, the payout number corresponding to the type of the symbols which have stopped on the display regions q11 to q53 and to the number of stopped symbols is decided without setting an effective line. In FIG. 5, “PLUM”, “APPLE”, “LOBSTER” and “CRAB” individually represent names of the symbols. In the slot game, these symbols are set as scatter symbols. Moreover, in this embodiment, the specific symbol (“BONUS”) for shifting to the bonus game is set on the payout table. As shown in FIG. 5, in the case where three or more of the specific (bonus) symbols have appeared on the display regions, the slot machine 10 of this embodiment obtains the payouts, and the slot game proceeds to the bonus game.

Moreover, in the ROM 108, correspondence relationships between a code number representing each symbol and one or plural random number values belonging to a predetermined numeric range (0 to 255) are stored as weighted data for each of the display regions q11 to q53. For example, in the case where plural random number values corresponding to a certain symbol are set for the symbol concerned, a probability that the symbol is selected becomes higher than in the case where one random number value is set therefor. The weighted data is set based on a payout rate of each symbol (in the payout table shown in FIG. 5). Moreover, as the weighted data of each symbol, second weighted data for use in the bonus game is prepared as well as first data for use in a usual slot game.

The second weighted data is set so that a probability that the winning is generated can be increased. In the case of this embodiment, the generation of the winning stands for that a predetermined number or more of the scatter symbols appear among the plurality of symbols displayed still. The second weighted data is set so that a probability that the scatter symbols are selected can be increased. Moreover, besides such associations between the random number values and the above-described scatter symbols, an association between the random number value and the symbol (the letters “JP”) representing the jackpot winning is stored in the ROM 108. This association is activated in the bonus game (to be described later). In such a way, in the bonus game, a possibility that the jackpot winning will be selected is generated.

Moreover, in the case of this embodiment, the slot game is adapted to proceed to the bonus game in the case where three or more of the specific symbols have been displayed still. Stopped positions (display regions) of the specific (bonus) symbols displayed still in the case where the slot game proceeds to the bonus game are stored in a specific symbol information storage area 110D (FIG. 4) of the RAM 110. In the bonus game, the selection of the symbol representing the jackpot winning is activated only on the stopped positions (the display regions) stored in the specific symbol information storage area 110D of the RAM 110. In such a way, a possibility that the symbol representing the jackpot winning will be displayed still is generated only on the display regions described above.

On an occasion that a starting operation for the game has been received by the START switch 27, the CPU 106 reads out game execution programs from the ROM 108, and executes the game. The game execution programs are programs for executing the slot game through the display controller 140, and for performing the effect display, in which the first and second liquid crystal displays 16 and 17 coordinate with each other, through the display controllers 140 and 141.

Specifically, as the programs for executing the slot game, the game execution programs are programmed so as to execute the slot game. In the slot game, the payout is generated based on the payout table shown in FIG. 5 when the symbols are variably displayed simultaneously on the respective display regions q11 to q53 of the first liquid crystal display 16, the symbols are then stopped, and the symbols which compose the winning combination appear. Moreover, as the programs for executing the effect display corresponding to the result of the slot game, the game execution programs are programmed so as to execute the effect to be described below. In the effect concerned, in the case where the symbol (the letters “JP”) representing the jackpot winning, which is displayed still on any of the display regions q11 to q53 in the bonus game, is displayed as a result of the slot game executed on the first liquid crystal display 16, the symbol is changed to the character 201 resembling the rocket, and the character 201 is moved to the second liquid crystal display 17. Moreover, on the second liquid crystal display 17, the characters 202 to 206 for performing the game to decide the magnitude of the award (the payout) are displayed, and are then moved. Furthermore, the character 201 resembling the rocket is displayed and moved, and is made to hit any of the characters 202 to 206.

Moreover, to the input/output bus 104, there are connected: the random number generator 112; the communication interface circuit 111; the display controllers 140 and 141; the hopper driving circuit 124; the speaker driving circuit 122; and the display driving circuit 128.

The communication interface circuit 111 is connected to the hall server and the like. The communication interface circuit 111 transmits data on a history of the plays executed on the slot machine 10, and the like to the hall server, and receives a variety of data transmitted from the hall server.

The random number generator 112 generates random numbers for deciding whether or not to generate the winning combination and the jackpot in the slot game executed on the first liquid crystal display 16.

The display driving circuit 128 performs a control to display the number of payouts on the number-of-payouts display region 48 set on the lower left region of the first liquid crystal display 16.

The speaker driving circuit 122 outputs audio data to the speakers 29. Specifically, the CPU 106 reads out the audio data stored in the ROM 108, and transmits the audio data to the speaker driving circuit 122 through the input/output bus 104. In such a way, a predetermined effect sound is emitted from the speakers 29.

The hopper driving circuit 124 outputs a payout signal to the hopper 44 when cashout occurs. Specifically, upon receiving the cashout signal from the CASHOUT switch 23, the CPU 106 outputs a drive signal to the hopper driving circuit 124 through the input/output bus 104. In such a way, the hopper 44 pays out the medals of the number equivalent to the remaining number of credits at that point of time, which is stored in a predetermined memory region of the RAM 110.

The display controller 140 performs a display control to execute, on the first liquid crystal display 16, the slot game and the effect corresponding to the result of the slot game. Specifically, the CPU 106 generates a signal of an image display command corresponding to a state of the slot game and the result of the slot game, and outputs the signal of the image display command to the display controller 140 through the input/output bus 104. Upon receiving the signal of the image display command, which is outputted from the CPU 106, the display controller 140 generates a drive signal for driving the first liquid crystal display 16 based on the image display command, and outputs the drive signal thus generated to the first liquid crystal display 16. In such a way, on the first liquid crystal display 16, an effect screen corresponding to the slot game and the result thereof, which is described above with reference to FIG. 1, is displayed.

The display controller 141 performs a display control to execute, on the second liquid crystal display 17, the effect corresponding to the result of the slot game. Specifically, the CPU 106 generates the signal of the image display command corresponding to the state of the slot game and the result of the slot game, and outputs the signal of the image display command to the display controller 141 through the input/output bus 104. Upon receiving the signal of the image display command, which is outputted from the CPU 106, the display controller 141 generates a drive signal for driving the second liquid crystal display 17 based on the image display command, and outputs the drive signal thus generated to the second liquid crystal display 17. In such a way, the effect screen described with reference to FIG. 1 is displayed on the second liquid crystal display 17.

The above-described image display commands are: one for displaying, on the first liquid crystal display 16, the image of the slot game and such an effect image corresponding to the result of the slot game; and one for displaying, on the second liquid crystal display 17, such an effect image corresponding to the result of the slot game. The CPU 106 outputs these image display commands to the display controllers 140 and 141 individually at timing corresponding to the progress of the slot game. In such a way, on the first liquid crystal display 16, the effect corresponding to the slot game and to the result thereof is made, and on the second liquid crystal display 17, the effect corresponding to the result of the slot game is made in coordination with the display on the first liquid crystal display 16.

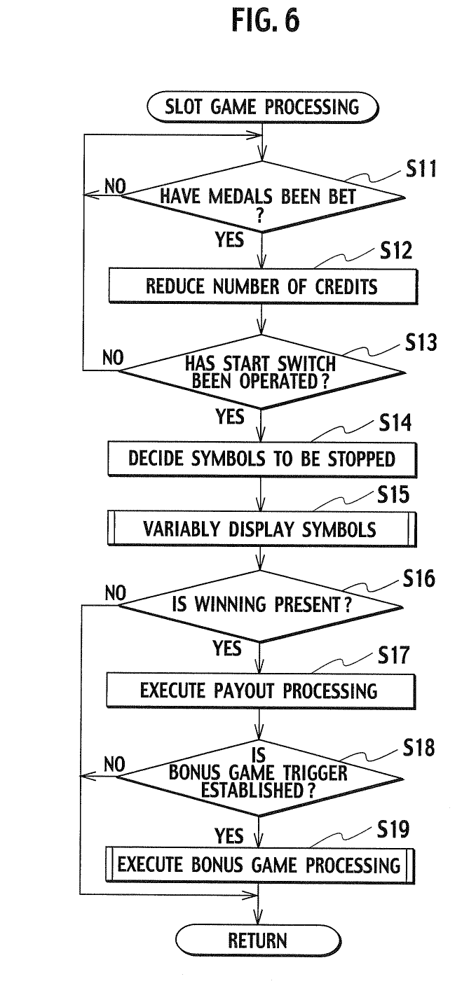

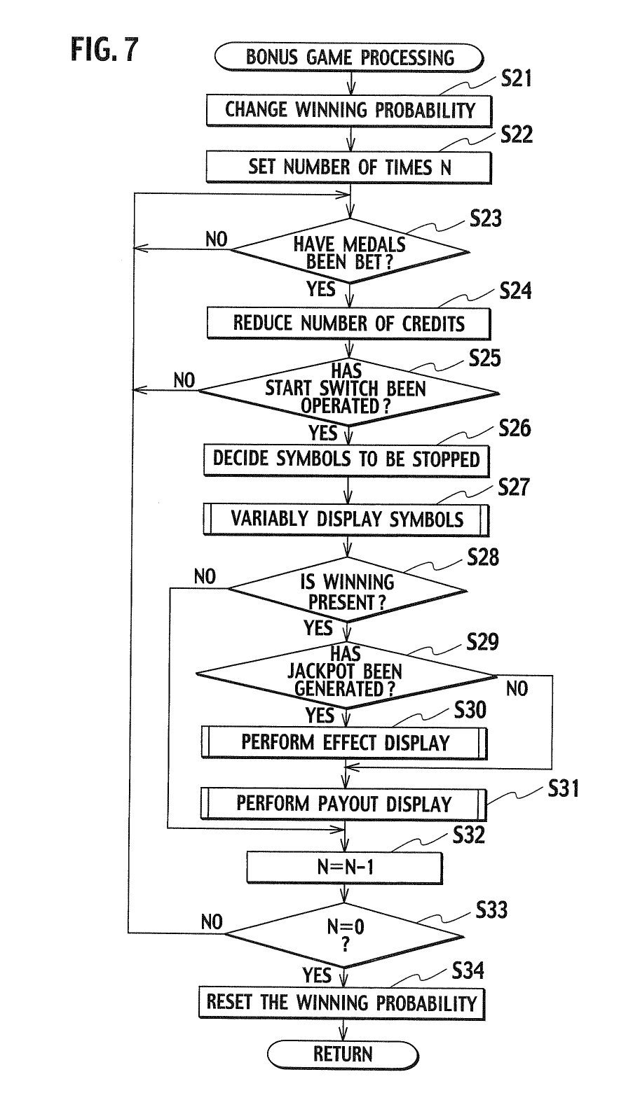

Next, a description will be made of operations of the slot machine according to this embodiment with reference to flowcharts shown in FIG. 6 and FIG. 7. FIG. 6 is a flowchart showing an execution processing procedure of the slot game executed by the controller 40 of the slot machine 10. This processing is processing in which the CPU 106 executes a slot game program stored in the ROM 108.

Upon entering slot game processing shown in FIG. 6, the CPU 106 judges in Step S11 whether or not the medals have been bet. In this processing, the CPU 106 judges whether or not to have received the signal outputted from the BET switch 25 when the BET switch 25 concerned is pressed or the signal outputted from the MAX BET switch 24 when the MAX BET switch 24 is pressed. In the case of having judged that the medals are not bet, the CPU 106 returns the processing to Step S11.

Meanwhile, in the case of having judged in Step S11 that the medals have been bet, the CPU 106 proceeds to Step S12, and reduces the number of credits, which is stored in the RAM 110, in response to the number of bet medals.

Next, in Step S13, the CPU 106 judges whether or not the START switch 27 has been pressed. In this processing, the CPU 106 judges whether or not to have received the signal outputted from the START switch 27 when the START switch 27 concerned is pressed.

In the case of having judged that the START switch 27 is not pressed, the CPU 106 returns the processing to Step S11. Note that, in the case where the START switch 27 is not pressed (for example, in the case where the START switch 27 is not pressed, but an instruction to the effect that the game will be ended is inputted to the CPU 106), the CPU 106 cancels a result of reducing the number of credits in Step S12.

Then, in the case of having judged in Step S13 that the START switch 27 has been operated to be pressed, the CPU 106 proceeds from Step S13 to Step S14, and decides the symbols to be stopped. In such stop symbol decision processing, the CPU 106 executes a stop symbol decision program as one of the game execution programs stored in the ROM 108, and thereby decides the symbols to be displayed still on the respective display regions q11 to q53. In this processing, the CPU 106 executes a random number generation program, and thereby selects the random number value from the numeric values of “0 to 255” for each of the display regions q11 to q53. Then, the CPU 106 refers to the associations between the random number values and the symbols, which are stored in the ROM 108, and thereby decides the symbols to be stopped.

Next, in Step S15, the CPU 106 performs variable display processing for the symbols. This processing is processing for starting the variable display of the symbols on the respective display regions q11 to q53, and thereafter stopping the variable display. By this processing for starting and stopping the variable display, the symbols are rearranged on the respective display regions q11 to q53.

After the variable display processing is ended, the CPU 106 proceeds to Step S16, and judges whether or not the winning has occurred based on the stopped symbols. In short, the CPU 106 judges whether or not conditions for generating the award have been satisfied. In Step S16, the CPU 106 refers to the payout table shown in FIG. 5, and judges whether or not the number and type of symbols of the same type among the symbols stopped in Step S15 described above coincide with any of the combinations of the types and the numbers, which are set in the payout table. In the case where such a coincidence is made, the CPU 106 judges that the winning has been established, decides the payout number of medals, which is set in response to the type and number of symbols of the same type, and proceeds from Step S16 to Step S17. In this case, among the rearranged symbols, the symbols coinciding with the combination of the type and the number, which is set in the payout table, are symbols which satisfy the conditions for generating the award. Meanwhile, in the case where the number and type of symbols of the same type among the symbols which have stopped in Step S15 described above do not coincide with any of the combinations of the types and numbers, which are set in the payout table, the CPU 106 judges that the winning has not been established, returns to Step S11 described above, and executes the next slot game.

In Step S17, the CPU 106 executes medal payout processing corresponding to a result of the winning in Step S16 described above. In this payout processing, the CPU 106 adds the number of credits generated in Step S16 described above to the number of credits, which is stored in the RAM 110.

After the payout processing is ended, the CPU 106 proceeds to Step S18, and judges whether or not a bonus trigger is established based on the symbols rearranged on the display regions q11 to q53 as a result of being variably displayed thereon in Step S15 described above. In the slot machine 10, as conditions for establishing the bonus trigger, the specific (bonus) symbols and the number thereof are pre-stored in the payout table (FIG. 5) of the ROM 108. In the case of this embodiment, it is judged that the bonus trigger is established when the bonus symbols have been displayed still on three or more of the display regions q11 to q53. The CPU 106 judges whether or not such a combination is present among the symbols stopped in Step S15 described above. Then, in the case where this combination is present, the CPU 106 judges that the bonus trigger has been established, and stores the stopped positions (the display regions) of the specific (bonus) symbols related to this combination in the specific symbol information storage area 110D of the RAM 110. Moreover, the CPU 106 proceeds from Step S18 to Step S19, and executes bonus game processing. The stopped positions (the display regions) stored in the specific symbol information storage area 110D become positions where the symbols of the jackpot winning stop in the bonus game.

The bonus game is a game in which games advantageous to the player progress, for example, a predetermined number of times. Meanwhile, in the case where the combination as the conditions for establishing the bonus trigger is not present among the symbols displayed still in Step S15 described above, the CPU 106 returns from Step S18 to Step S11 described above, and proceeds to the next slot game.

As described above, in the slot machine 10, the slot game processing shown in FIG. 6 is executed, whereby the slot game is started under game starting conditions where the medals are bet and the START switch is operated to be pressed. Then, the symbols to be stopped are decided, and the symbols of the respective display regions q11 to q53 are variably displayed thereon so as to stop in a pattern of the decided symbols to be stopped.

Then, it is judged whether or not the winning is established in response to the decided symbols to be stopped (the symbols which have stopped on the respective display regions q11 to q53). In the case where the winning is established, the medals of the number corresponding to the contents of the winning are paid out.

Moreover, it is decided whether or not each of the games is to proceed to the bonus game. In the case where it has been decided that the game is to proceed to the bonus game, the bonus games are executed from the next game the pre-set number of times.

FIG. 7 is a flowchart showing a bonus game processing procedure in Step S19 of FIG. 6. Upon entering the bonus game in Step S19 described above with reference to FIG. 6, the CPU 106 proceeds to Step S21 shown in FIG. 7.

In Step S21, the CPU 106 changes the weighted data set in the ROM 108 to the weighted data for the bonus game. In such a way, in the bonus game, the probability that the scatter symbols are selected is increased.

Then, in subsequent Step S22, the CPU 106 sets, in the RAM 110, the number of times N that the bonus games are executed. The number of times N is predetermined.

In Step S23, the CPU 106 judges whether or not the medals have been bet. In this Step S23, processing similar to that in Step S11 described with reference to FIG. 6 is performed. When the medals are bet, the CPU 106 obtains a positive result in Step S23, and thereby proceeds to Step S24, and reduces the number of credits, which is stored in the RAM 110. This reduction processing is processing similar to that in Step S12 described above with reference to FIG. 6.

Then, the CPU 106 proceeds to Step S25, and judges whether or not the START switch has been operated. In the case where the START switch has been operated, the CPU 106 proceeds to Step S26, and selects the random number values based on such a winning probability (the weighted data) changed in Step S21 described above, and thereby decides the symbols to be stopped on the respective display regions q11 to q53.

When the symbols to be stopped are decided as described above, the CPU 106 proceeds to Step S27, and variably displays the symbols on the respective display regions q11 to q53. Then, in Step S28, the CPU 106 judges whether or not the winning has been generated based on the combination (the number of scatter symbols of the same type) of the selected symbols to be stopped.

In this case, in the payout table shown in FIG. 5, the number of credits to be given in response to the type and number of stopped (selected) scatter symbols is set. The CPU 106 judges the generation (the payout) of the winning based on the payout table.

When a negative result is obtained in this Step S28, this stands for that the winning is not generated. Then, the CPU 106 proceeds from Step S28 to Step S32. On the contrary, when a positive result is obtained in Step S28, this stands for that the winning has been generated. Then, the CPU 106 proceeds from Step S28 to Step 29, and judges whether or not the jackpot winning has been generated.

Here, the stopped positions (the display regions) of the bonus symbols which have served as an occasion to proceed to the bonus game are stored in the specific symbol information storage area 110D of the RAM 110. In the case where the symbol (the letters “JP”) representing the jackpot winning is displayed still on one of the stopped positions (the display regions), the CPU 106 judges that the jackpot winning has been generated. Then, as the jackpot winning, the CPU 106 decides any of the winning types of “MEGA”, “MAJOR”, “MINI”, “500” and “300”. In this case, the associations between the random number values and the respective winning types are pre-stored in the ROM 108. The CPU 106 selects the random number values, and reads out the winning type corresponding to the selected random number values from the ROM 108.

In the case where the jackpot winning has been generated as described above, the CPU 106 obtains a positive result in Step S29, and thereby proceeds to Step S30, and performs the effect display (FIG. 1) corresponding to the jackpot winning on the first and second liquid crystal displays 16 and 17 in the coordination manner.

Then, in Step S31, the CPU 106 pays out the credits corresponding to a result of the winning, and thereafter, reduces a value of N by one (N=N−1) in Step S32. In Step S33, the CPU 106 judges whether or not a result of the reduction of N is 0. When a negative result is obtained in Step S33, this stands for that the number of times of the bonus games has not reached the preset number of times, and the CPU 106 returns to Step S23 described above, and executes the next bonus game. On the contrary, when a positive result is obtained in Step S33, this stands for that the bonus games have been executed such a prescribed number of times. Then, the CPU 106 proceeds to Step S34, and changes the weighted data for use from the second weighted data for the bonus game to the first weighted data for the usual game, and thereby decreases the winning probability for the usual game. Then, the CPU 106 returns to the usual slot game processing shown in FIG. 6.

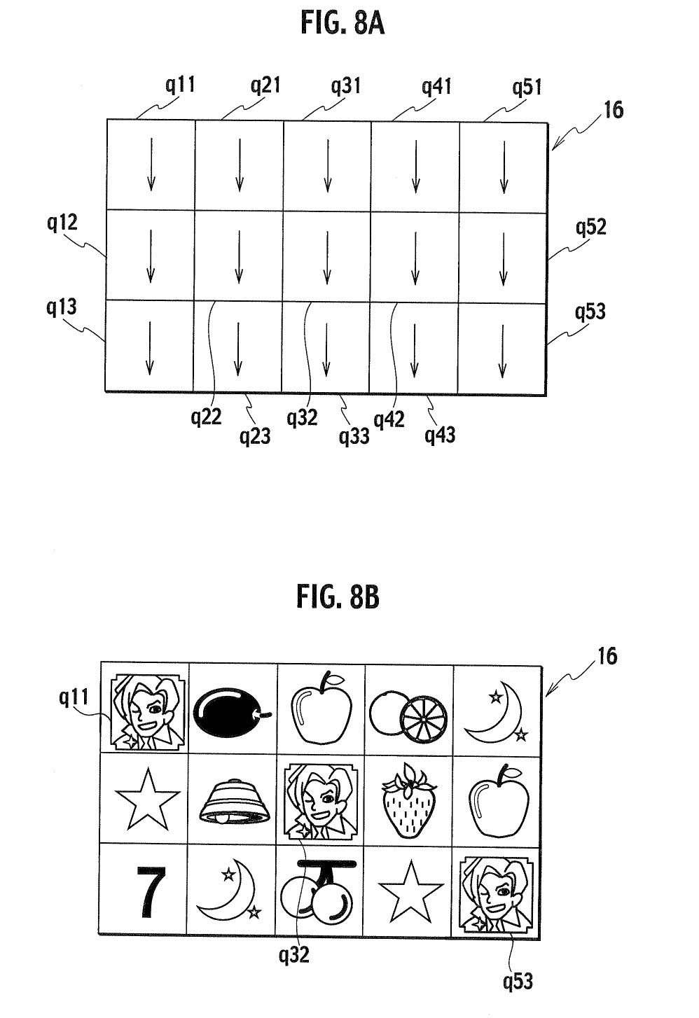

FIG. 8A to FIG. 11 show display examples of the slot games on the first liquid crystal display 16 and effect display examples on the first and second liquid crystal displays 16 and 17 when the slot games in FIGS. 6 and 7 described above are executed.

In the slot machine 10, the slot game processing shown in FIG. 6 is executed, and the START switch 27 (FIG. 2) is operated, whereby the slot game is started. Then, as shown in FIG. 8A, the variable display is started on all of the display regions q11 to q53 of the first liquid crystal display 16. Note that arrows in FIG. 8A indicate a state where the symbols are variably displayed.

Then, as shown in FIG. 8B, on the display regions q11 to q53 on which the symbols have been variably displayed, the symbols decided in Step S14 are displayed still. Among the symbols thus displayed still, the symbols displayed still on the display regions q11, q32 and q53 are the special (bonus) symbols. In this case, the game will proceed to the bonus game in response to that three special (bonus) symbols have been selected (displayed still).

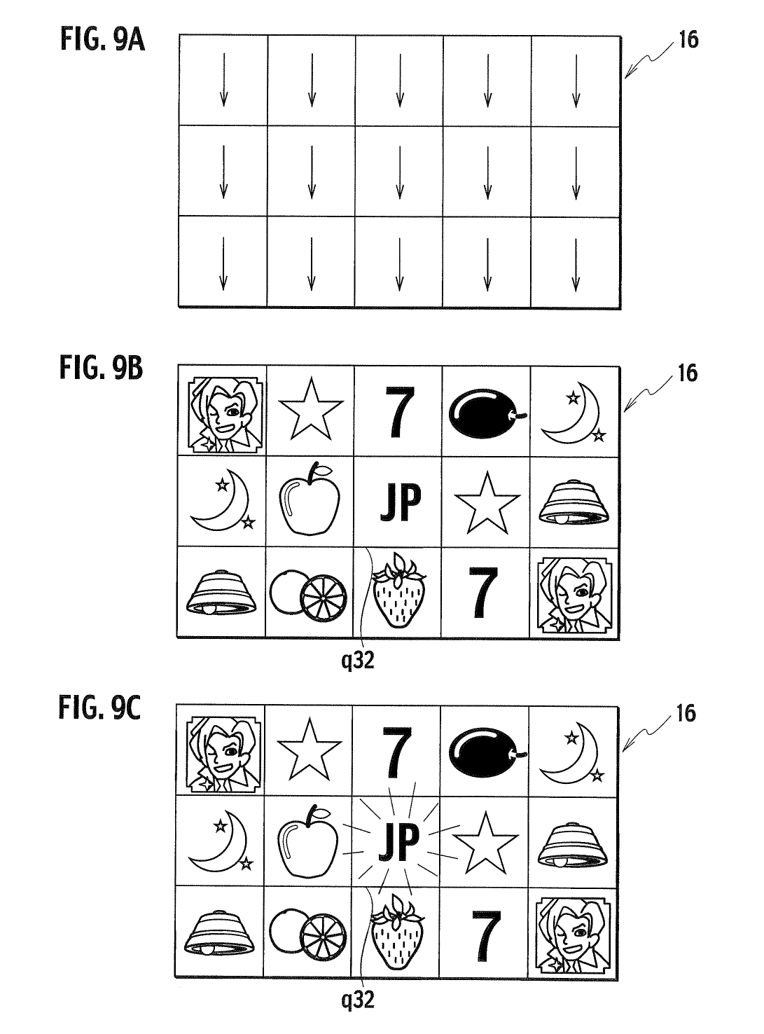

After the slot game has proceeded to the bonus game, the slot machine 10 executes the bonus game processing shown in FIG. 7. Then, the START switch 27 is operated, whereby the slot machine 10 variably displays the symbols on all the display regions q11 to q53 as shown in FIG. 9A. Thereafter, the slot machine 10 displays still the symbols decided in Step S26 of FIG. 7 on the respective display regions q11 to q53.

Here, when the jackpot winning is generated in the case where the slot game has proceeded to the bonus game by the fact that the special (bonus) symbols have stopped on the display regions q11, q32 and q53 as shown in FIG. 8B, the symbol (the letters “JP”) representing the jackpot winning is displayed still on any of the display regions q11, q32 and q53. Specifically, as shown in FIG. 9B, the symbol representing the jackpot winning is displayed still, for example, on the display region q32 among the three display regions q11, q32 and q53. Incidentally, when the symbol representing the jackpot winning is displayed still, brightness of the symbol concerned is increased as shown in FIG. 9C, whereby the generation of the winning is displayed to the player so as to be easily understandable.

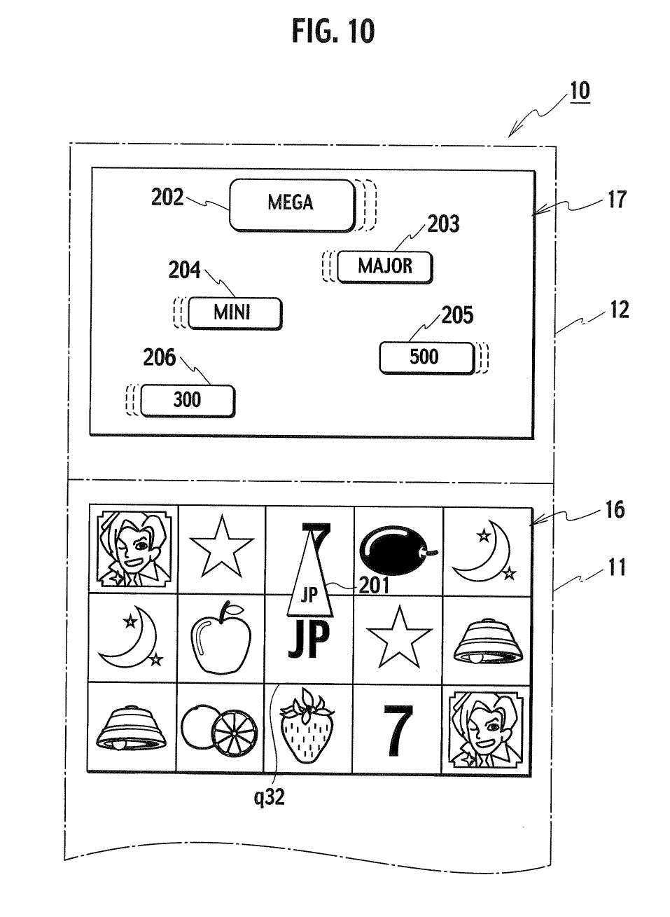

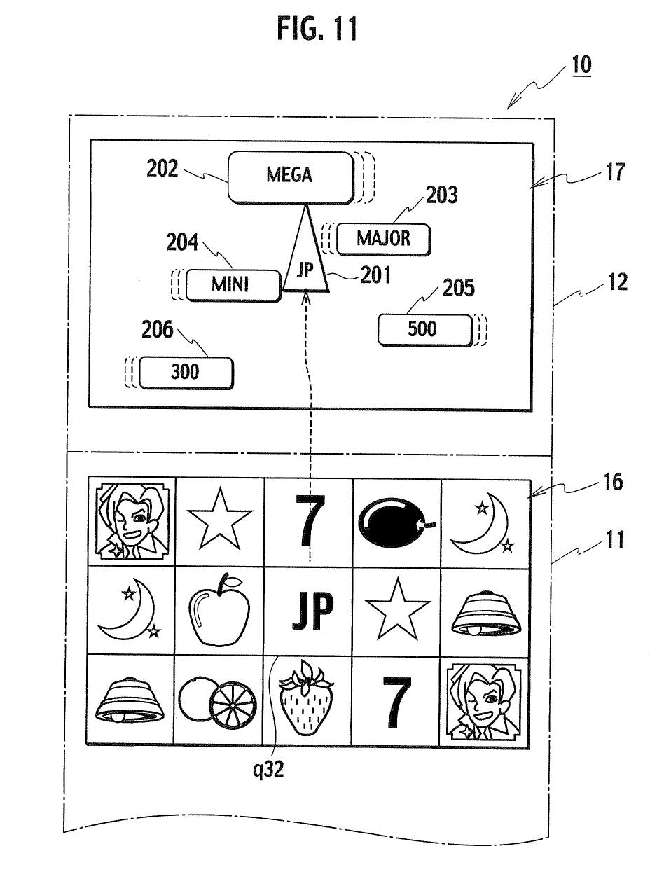

When the jackpot winning is generated, the effect display is executed on the first and second liquid crystal displays 16 and 17 in the coordination manner in Step S30 of FIG. 7. Specifically, as shown in FIG. 10, on the first liquid crystal display 16, the character 201 resembling the rocket is displayed on the display region q32 on which the symbol representing the jackpot winning has been displayed. Then, as shown in FIG. 11, the character 201 moves from the first liquid crystal display 16 to the second liquid crystal display On the second liquid crystal display 17, the characters 202 to 206 representing the types (“MEGA”, “MAJOR”, “MINI”, “500” and “300”) of the jackpot winning are displayed so as to move left and right. The character 201 moves so as to hit the symbol (any of the characters 202 to 206) corresponding to the decided wining type.

As described above, the display that reaches the bonus game from the usual slot game is executed on the first liquid crystal display 16, and when the jackpot winning is generated in the bonus game, the effect that decides the type (the payout) of the jackpot winning is executed on the second liquid crystal display 17 in coordination with the effect on the first liquid crystal display 16.

From the above, the effect display is executed on the first and second liquid crystal displays 16 and 17 in the coordination manner, whereby new effect display corresponding to the change of the circumstances of the slot game from the bonus game to the jackpot winning is realized.

In the above-described embodiment, the description has been made of the case where the symbol representing the jackpot winning is displayed still on any of the display regions on which the special (bonus) symbols have stopped. Here, the special (bonus) symbols serve as the conditions for proceeding to the bonus game. However, the present invention is not limited to the case of this embodiment. For example, the symbol representing the jackpot winning may be adapted to be stopped on any of the columns (of the display regions q11 to q13, q31 to q33, and q51 to q53) to which the display regions (for example, the display regions q11, q32 and q53) belong. Here, the display regions q11, q32 and q53 are the display regions on which the special (bonus) symbols have stopped when the game has proceeded to the bonus game.

Moreover, in the above-described embodiment, the description has been made of the case of using the first and second liquid crystal displays 16 and 17 as the first and second displays; however, the present invention is not limited to the case of this embodiment. For example, other displays such as a display using electroluminescent elements may be adapted to be used.

What is claimed is:

1. A slot machine comprising:
a first display on which a slot game is performed to display one selected from among a plurality of symbols in each of a plurality of display regions thereof and on which an effect display regarding a result of the slot game is performed;
a second display on which an effect display regarding the result of the slot game is performed; and
a controller that coordinates displays of the first display and the second display to perform the effect displays on the first display and the second display.

2. The slot machine according to claim 1, wherein the controller:
displays the result of the slot game on the first display; and
performs on the second display an effect display regarding a magnitude of an award generated in response to the result of the slot game.

3. The slot machine according to claim 1, wherein the controller:
displays on the first display a notification that a jackpot is won as the result of the slot game; and
performs on the second display the effect display regarding the result of the slot game to decide a payout for the winning.

4. The slot machine according to claim 1, wherein the slot game shifts to a game advantageous to a player when one or more first specific symbols are displayed in a predetermined number of the display regions and
the controller performs the effect displays when a second specific symbol is displayed in at least one of the display regions in the game advantageous to the player.

5. A slot machine comprising:
a first display on which a slot game is performed to display one selected from among a plurality of symbols in each of a plurality of display regions thereof;
a second display on which an effect display regarding a result of the slot game is performed; and
a controller that displays the result of the slot game on the first display and performs on the second display an effect display regarding a magnitude of an award generated in response to the result of the slot game.

6. The slot machine according to claim 5, wherein the controller:
displays on the first display a notification that a jackpot is won as the result of the slot game; and
performs on the second display the effect display regarding the result of the slot game to decide a payout for the winning.

7. The slot machine according to claim 5, wherein the slot game shifts to a game advantageous to a player when one or more first specific symbols are displayed in a predetermined number of the display regions and
the controller performs the effect display regarding the magnitude of the award when a second specific symbol is displayed in at least one of the display regions in the game advantageous to the player.

8. The slot machine according to claim 7, wherein, when a symbol indicating that a jackpot is won is displayed as the second specific symbol, the controller performs the effect display regarding the magnitude of the award to decide a payout for the winning.

9. A slot machine comprising:
a first display on which a slot game is performed to display one selected from among a plurality of symbols in each of a plurality of display regions thereof;
a second display on which an effect display regarding a result of the slot game is performed; and
a controller that displays on the first display a notification that a jackpot is won as the result of the slot game and performs on the second display the effect display regarding the result of the slot game to decide a payout for the winning.

10. The slot machine according to claim 9, wherein the controller performs the effect display when the jackpot is won and a condition for shifting to a game advantageous to a player is satisfied as the result of the slot game.

11. A slot machine comprising:
a first display on which a slot game is performed to display one selected from among a plurality of symbols in each of a plurality of display regions thereof and on which an effect display regarding a result of the slot game is performed;
a second display on which an effect display regarding the result of the slot game is performed; and
a controller that coordinates displays of the first display and the second display to perform the effect displays on the first display and the second display,
wherein, when a jackpot is won and a condition for shifting to a game advantageous to a player is satisfied as the result of the slot game, the controller performs the effect displays to decide a payout for the winning.

12. The slot machine according to claim 11, wherein the slot game shifts to the game advantageous to the player when one or more first specific symbols are displayed in a predetermined number of the display regions and
the controller performs the effect displays when a second specific symbol is displayed in at least one of the display regions in the game advantageous to the player.

13. A method for controlling a slot machine comprising:
performing a slot game in which one selected from among a plurality of symbols is displayed in each of a plurality of display regions of a first display provided on the slot machine; and
performing effect displays regarding a result of the slot game on the first display and a second display provided on the slot machine in a coordination manner.
